(19) United States
(12) Patent Application Publication
(10) Pub. No.: US 2026/0152517 A1
(43) Pub. Date: Jun. 4, 2026

(54) HIGH PURITY PRECURSOR COMPOSITIONS AND RELATED METHODS

(71) Applicant: ENTEGRIS, INC., Billerica, MA (US)

(72) Inventor: David Kuiper, Brookfield, CT (US)

(21) Appl. No.: 19/409,601

(22) Filed: Dec. 4, 2025

Related U.S. Application Data
(60) Provisional application No. 63/728,130, filed on Dec. 4, 2024.

(51) Int. Cl. C07F 11/00

(52) U.S. Cl. CPC C07F 11/00; C07F 11/005

(57) ABSTRACT

High purity precursor compositions and related methods are provided herein. The method includes obtaining a metal complex and a reagent. The method includes contacting the metal complex and the reagent to form a reaction product. The reaction product has a purity of at least 85% as determined by a thermogravimetric analysis (TGA) residue at 300° C. The reaction product can be used as a deposition precursor.

### CROSS-REFERENCE TO RELATED APPLICATIONS

This application claims the benefit under 35 USC 119 of U.S. Provisional Patent Application No. 63/728,130, filed Dec. 4, 2025, the disclosure of which is hereby incorporated herein by reference in its entirety.

### FIELD

The present disclosure relates to high purity precursor compositions and related methods.

### BACKGROUND

Metal precursors are useful in the manufacturing of microelectronic devices.

### SUMMARY

Some embodiments relate to a composition. In some embodiments, the composition comprises a metal complex of the formula:

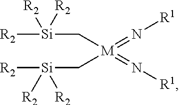

where:
M comprises at least one of a molybdenum, a tungsten, or any combination thereof;
each R¹ independently comprises a C₁-C₄ alkyl; and
each R² independently comprises a C₁-C₄ alkyl.

In some embodiments, the metal complex has a purity of at least 85% as determined by a thermogravimetric analysis (TGA) residue at 300° C.

Some embodiments relate to a composition. In some embodiments, the composition comprises a molybdenum complex of the formula:

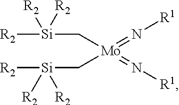

where:
each R¹ independently comprises a C₁-C₄ alkyl; and
each R² independently comprises a C₁-C₄ alkyl.

In some embodiments, the composition comprises 0.001% to 15% by weight of an impurity based on a total weight of the composition.

Some embodiments relate to a composition. In some embodiments, the composition comprises a compound of the formula:

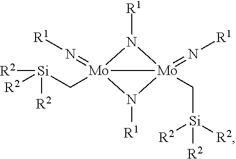

where:
each R¹ independently comprises a C₁-C₄ alkyl; and
each R² independently comprises a C₁-C₄ alkyl.

Some embodiments relate to a method. In some embodiments, the method comprises obtaining a metal complex of the formula:

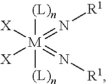

where:
M comprises at least one of a molybdenum, a tungsten, or any combination thereof;
each R¹ independently comprises a C₁-C₄ alkyl;
each L independently comprises at least one of an amino, a nitrile, an isonitrile, an ether, a diether, a thioether, a phosphino, a diphosphino, a heterocyclic, a guanidine, an amidine, an alkene, an alkyne, a cycloalkene, a cycloalkyne, or any combination thereof;
each n is independent 0 or 1; and
each X independently comprises a halogen.

In some embodiments, the method comprises obtaining a reagent of the formula:

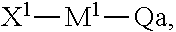

wherein:
X¹ comprises a halogen;
M¹ comprises at least one of an alkali metal, an alkaline earth metal, a zinc, or any combination thereof;
Q comprises (CH₂)_{b}—Si(R²)₃,
where:
each R² independently comprises a C₁-C₄ alkyl;
b is 0 to 4; and
a is 1 or 2.

In some embodiments, the method comprises contacting the metal complex and the reagent to form a reaction product. In some embodiments, the reaction product has a purity of at least 85% as determined by a TGA residue at 300° C.

### BRIEF DESCRIPTION OF THE DRAWINGS

FIG. 1 is a flowchart of a method for forming a reaction product 100, according to some embodiments.

FIG. 2 is a thermogravimetric analysis (TGA) of the distilled reaction product of Example 1.

FIG. 3 is a TGA of the crude reaction product of Example 2.

FIG. 4 is a TGA of the distilled reaction product of Example 2.

FIG. 5 is a TGA of the distilled reaction product of Example 3.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cn alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₃ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkene” refers to a non-aromatic carbocyclic ring having from 3 to 8 carbon atoms with at least one double bond in the ring. The term includes a monocyclic non-aromatic carbocyclic ring and a polycyclic non-aromatic carbocyclic ring. The term “monocyclic,” when used as a modifier, refers to a cycloalkene having a single cyclic ring structure. The term “polycyclic,” when used as a modifier, refers to a cycloalkene having more than one cyclic ring structure, which may be fused, bridged, spiro, or otherwise bonded ring structures. For example, two or more cycloalkenes may be fused, bridged, or fused and bridged to obtain the polycyclic non-aromatic carbocyclic ring. In some embodiments, the cycloalkene may comprise, consist of, or consist essentially of, or may be selected from the group consisting of, at least one of cyclopropene, cyclobutene, cyclopentene, cyclohexene, cycloheptene, cyclooctene, or any combination thereof.

As used herein, the term “cycloalkyne” refers to a non-aromatic carbocyclic ring having from 3 to 12 carbon atoms with at least one triple bond in the ring. The term includes a monocyclic non-aromatic carbocyclic ring and a polycyclic non-aromatic carbocyclic ring. The term “monocyclic,” when used as a modifier, refers to a cycloalkyne having a single cyclic ring structure. The term “polycyclic,” when used as a modifier, refers to a cycloalkyne having more than one cyclic ring structure, which may be fused, bridged, spiro, or otherwise bonded ring structures. For example, two or more cycloalkynes may be fused, bridged, or fused and bridged to obtain the polycyclic non-aromatic carbocyclic ring. In some embodiments, the cycloalkyne may comprise, consist of, or consist essentially of, or may be selected from the group consisting of, at least one of cyclopropyne, cyclobutyne, cyclopentyne, cyclohexyne, cycloheptyne, cyclooctyne, cyclodecyne, cycloundecyne, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl)amine, tetra(aminomethyl)methane, diethylenetriamine, triethylenetetramine, tetraethylpentamine, heptaethyleneoctamine, nonaethylenedecamine, and diazabicyloundecene. Unless otherwise provided herein, the terms “amine” and “amino” may be used interchangeably throughout this disclosure.

As used herein, the term “ether” refers to a functional group of the formula R^{a}OR^{b}, wherein R^{a} and R^{b} are each independently an alkyl (as defined herein) or an aryl (as defined herein).

As used herein, the term “thioether” refers to a functional group of the formula R^{a}SR^{b}, wherein R^{a} and R^{b} are each independently an alkyl (as defined herein) or an aryl (as defined herein).

As used herein, the term “phosphino” refers to a functional group of the formula PR^{a}R^{b}R^{c}, wherein R^{a}, R^{b}, and R^{c} are each independently an alkyl (as defined herein) or an aryl (as defined herein).

As used herein, the term “heterocyclic” refers to an aromatic or non-aromatic ring having 3 to 8 atoms and at least two different elements as members of the ring. The at least two different elements are carbon, oxygen, nitrogen, sulfur, and phosphorous. In some embodiments, the heterocyclic may comprise, consist of, or consist essentially of, or may be selected from the group consisting of, at least one of an aromatic nitrogen-containing ring, a non-aromatic nitrogen-containing ring, an aromatic oxygen-containing ring, a non-aromatic oxygen-containing ring, an aromatic sulfur-containing ring, a non-aromatic sulfur-containing ring, an aromatic phosphorous-containing ring, a non-aromatic phosphorous-containing ring, or any combination thereof.

As used herein, the term “amidine” refers to a functional group of formula —C(═NR^{a})N(R^{b}R^{c}), wherein R^{a}, R^{b}, and R^{c} are each independently a hydrogen or an alkyl, as defined here. In some embodiments, the term “amidine” refers to a functional group of formula —C(═NH)N(R^{b}R^{c}), where R^{b} and R^{c} are not hydrogen. In some embodiments, the term “amidine” refers to a functional group of formula —C(═NR^{a})N(HR^{c}), where R^{a} and R^{c} are not hydrogen. In some embodiments, the term “amidine” refers to a functional group of formula —C(═NH)N(HR^{c}), where R^{c} is not hydrogen. In some embodiments, the term “amidine” refers to a functional group of formula —C(═NR^{a})N(R^{b}R^{c}), wherein R^{a}, R^{b}, and R^{c} are not hydrogen.

As used herein, the term “guanidine” refers to a functional group of formula —C(═NR^{a})N(R^{b}R^{c})N(R^{d}R^{e}), wherein R^{a}, R^{b}, R^{c}, R^{d}, and R^{e} are each independently a hydrogen or an alkyl, as defined here. In some embodiments, the term “guanidine” refers to a functional group of formula —C(═NH)N(R^{b}R^{c})N(R^{d}R^{e}), wherein R^{b}, R^{c}, R^{d}, and R^{e} are not hydrogen. In some embodiments, the term “guanidine” refers to a functional group of formula —C(═NR^{a})N(HR^{c})N(R^{d}R^{e}), wherein R^{a}, R^{c}, R^{d}, and R^{e} are not hydrogen. In some embodiments, the term “guanidine” refers to a functional group of formula —C(═NR^{a})N(H₂)N(R^{d}R^{e}), wherein R^{a}, R^{d}, and R^{e} are not hydrogen. In some embodiments, the term “guanidine” refers to a functional group of formula —C(═NH)N(HR^{c})N(R^{d}R^{e}), wherein R^{c}, R^{d}, and R^{e} are not hydrogen. In some embodiments, the term “guanidine” refers to a functional group of formula —C(═NR^{a})N(H₂)N(HR^{e}), wherein R^{a} and R^{e} are not hydrogen. In some embodiments, the term “guanidine” refers to a functional group of formula —C(═NH)N(H₂)N(HR^{e}), wherein R^{c} is not hydrogen.

As used herein, the term “halide” or “halogen” refers to a —Cl, —Br, —I, or —F.

Metal complexes may be used as precursors to deposit metal containing films on a substrate by one or more deposition processes. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

Some embodiments relate to a composition. In some embodiments, the composition comprises a metal complex of the formula:

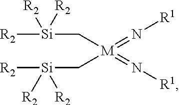

where:
M comprises at least one of a molybdenum, a tungsten, or any combination thereof;
each R¹ independently comprises an alkyl; and
each R² independently comprises an alkyl.

In some embodiments, M comprises a molybdenum. In some embodiments, M comprises a tungsten.

In some embodiments, the metal complex has a purity of at least 85% as determined by a thermogravimetric analysis (TGA) residue at 300° C. For example, in some embodiments, the metal complex has a purity of at least 86%, at least 87%, at least 88%, at least 89%, at least 90%, at least 91%, at least 92%, at least 93%, at least 94%, at least 95%, at least 96%, at least 97%, at least 98%, at least 99%, or at least 99.999% as determined by a TGA residue at 300° C.

In some embodiments, the metal complex has a purity of 85% to 99.999% as determined by a TGA residue at 300° C., or any range or subrange between 85% to 99.999%. For example, in some embodiments, the metal complex has a purity of 86% to 99.99%, 87% to 99.9%, 88% to 99%, 89% to 98%, 90% to 97%, 91% to 96%, 92% to 95%, or 93% to 94% as determined by a TGA residue at 300° C. In some embodiments, the metal complex has a purity of 86% to 99.999%, 87% to 99.999%, 88% to 99.999%, 89% to 99.999%, 90% to 99.999%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.9% to 99.999%, or 99.99% to 99.999% as determined by a TGA residue at 300° C. In some embodiments, the metal complex has a purity of 85% to 99.99%, 85% to 99.9%, 85% to 99%, 85% to 98%, 85% to 97%, 85% to 96%, 85% to 95%, 85% to 94%, 85% to 93%, 85% to 92%, 85% to 91%, 85% to 90%, 85% to 89%, 85% to 88%, 85% to 87%, or 85% to 86% as determined by a TGA residue at 300° C.

In some embodiments, each R¹ independently comprises an alkyl. In some embodiments, each R¹ comprises the same alkyl. In some embodiments, each R¹ comprises a different alkyl.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, each R¹ comprises the same alkyl as each R². In some embodiments, at least one R¹ comprises the same alkyl as at least one R². In some embodiments, at least one R¹ comprises a different alkyl than at least one R².

In some embodiments, the metal complex comprises the formula:

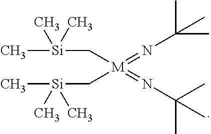

Some embodiments relate to a composition. In some embodiments, the composition comprises a molybdenum complex of the formula:

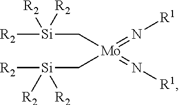

where:
each R¹ independently comprises an alkyl; and
each R² independently comprises an alkyl.

In some embodiments, each R¹ independently comprises an alkyl. In some embodiments, each R¹ comprises the same alkyl. In some embodiments, each R¹ comprises a different alkyl.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, each R¹ comprises the same alkyl as each R². In some embodiments, at least one R¹ comprises the same alkyl as at least one R². In some embodiments, at least one R¹ comprises a different alkyl than at least one R².

In some embodiments, the molybdenum complex comprises the formula:

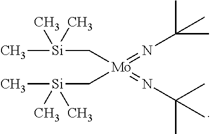

In some embodiments, the composition comprises 85% to 99.999% by weight of the molybdenum complex based on the total weight of the composition, or any range or subrange between 85% to 99.999%. For example, in some embodiments, the composition comprises 86% to 99.99%, 87% to 99.9%, 88% to 99%, 89% to 98%, 90% to 97%, 91% to 96%, 92% to 95%, or 93% to 94% by weight of the molybdenum complex based on the total weight of the composition. In some embodiments, the composition comprises 86% to 99.999%, 87% to 99.999%, 88% to 99.999%, 89% to 99.999%, 90% to 99.999%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.9% to 99.999%, or 99.99% to 99.999% by weight of the molybdenum complex based on the total weight of the composition. In some embodiments, the composition comprises 85% to 99.99%, 85% to 99.9%, 85% to 99%, 85% to 98%, 85% to 97%, 85% to 96%, 85% to 95%, 85% to 94%, 85% to 93%, 85% to 92%, 85% to 91%, 85% to 90%, 85% to 89%, 85% to 88%, 85% to 87%, or 85% to 86% by weight of the molybdenum complex based on the total weight of the composition.

In some embodiments, the composition comprises 0.001% to 15% by weight of an impurity based on a total weight of the composition, or any range or subrange between 0.001% to 15%. For example, in some embodiments, the composition comprises 0.01% to 14%, 0.1% to 13%, 0.5% to 14%, 1% to 13%, 2% to 12%, 3% to 11%, 4% to 10%, 5% to 9%, or 6% to 8% by weight of an impurity based on a total weight of the composition. In some embodiments, the composition comprises 0.01% to 15%, 0.1% to 15%, 0.5% to 15%, 1% to 15%, 2% to 15%, 3% to 15%, 4% to 15%, 5% to 15%, or 6% to 15% by weight of an impurity based on a total weight of the composition. In some embodiments, the composition comprises 0.001% to 14%, 0.001% to 13%, 0.001% to 14%, 0.001% to 13%, 0.001% to 12%, 0.001% to 11%, 0.001% to 10%, 0.001% to 9%, 0.001% to 8%, 0.001% to 7%, 0.001% to 6%, 0.001% to 5%, 0.001% to 4%, 0.001% to 3%, 0.001% to 2%, 0.001% to 1%, 0.001% to 0.5%, 0.001% to 0.1%, or 0.001% to 0.01% by weight of an impurity based on a total weight of the composition.

In some embodiments, the impurity comprises the formula:

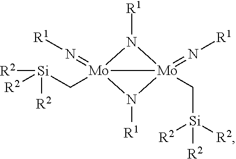

where:
each R¹ independently comprises an alkyl; and
each R² independently comprises an alkyl.

In some embodiments, each R¹ independently comprises an alkyl. In some embodiments, each R¹ comprises the same alkyl. In some embodiments, each R¹ comprises a different alkyl. In some embodiments, at least two R¹s comprise the same alkyl. In some embodiments, at least two R¹s comprise different alkyls. In some embodiments, at least three R¹s comprise the same alkyl. In some embodiments, at least three R¹s comprise different alkyls.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, each R¹ comprises the same alkyl as each R². In some embodiments, at least one R¹ comprises the same alkyl as at least one R². In some embodiments, at least one R¹ comprises a different alkyl than at least one R². In some embodiments, at least two R¹s comprise the same alkyl as at least two R²s. In some embodiments, at least two R¹s comprise a different alkyl from at least two R²s. In some embodiments, at least three R¹s comprise the same alkyl as at least three R²s. In some embodiments, at least three R¹s comprise a different alkyl from at least three R²s.

In some embodiments, the impurity comprises the formula:

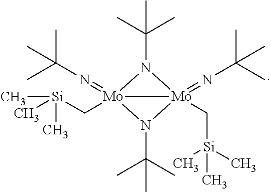

Some embodiments relate to a composition. In some embodiments, the composition comprises a compound of the formula:

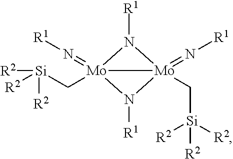

where:
each R¹ independently comprises an alkyl; and
each R² independently comprises an alkyl.

In some embodiments, each R¹ independently comprises an alkyl. In some embodiments, each R¹ comprises the same alkyl. In some embodiments, each R¹ comprises a different alkyl. In some embodiments, at least two R¹s comprise the same alkyl. In some embodiments, at least two R¹s comprise different alkyls. In some embodiments, at least three R¹s comprise the same alkyl. In some embodiments, at least three R¹s comprise different alkyls.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, each R¹ comprises the same alkyl as each R². In some embodiments, at least one R¹ comprises the same alkyl as at least one R². In some embodiments, at least one R¹ comprises a different alkyl than at least one R². In some embodiments, at least two R¹s comprise the same alkyl as at least two R²s. In some embodiments, at least two R¹s comprise a different alkyl from at least two R²s. In some embodiments, at least three R¹s comprise the same alkyl as at least three R²s. In some embodiments, at least three R¹s comprise a different alkyl from at least three R²s.

In some embodiments, the compound comprises the formula:

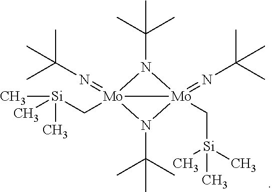

In some embodiments, the compound is present in an amount of 0.001% to 15% by weight based on a total weight of the composition, or any range or subrange between 0.001% to 15%. For example, in some embodiments, the compound is present in an amount of 0.01% to 14%, 0.1% to 13%, 0.5% to 14%, 1% to 13%, 2% to 12%, 3% to 11%, 4% to 10%, 5% to 9%, or 6% to 8% by weight based on a total weight of the composition. In some embodiments, the compound is present in an amount of 0.01% to 15%, 0.1% to 15%, 0.5% to 15%, 1% to 15%, 2% to 15%, 3% to 15%, 4% to 15%, 5% to 15%, or 6% to 15% by weight based on a total weight of the composition. In some embodiments, the compound is present in an amount of 0.001% to 14%, 0.001% to 13%, 0.001% to 14%, 0.001% to 13%, 0.001% to 12%, 0.001% to 11%, 0.001% to 10%, 0.001% to 9%, 0.001% to 8%, 0.001% to 7%, 0.001% to 6%, 0.001% to 5%, 0.001% to 4%, 0.001% to 3%, 0.001% to 2%, 0.001% to 1%, 0.001% to 0.5%, 0.001% to 0.1%, or 0.001% to 0.01% by weight based on a total weight of the composition.

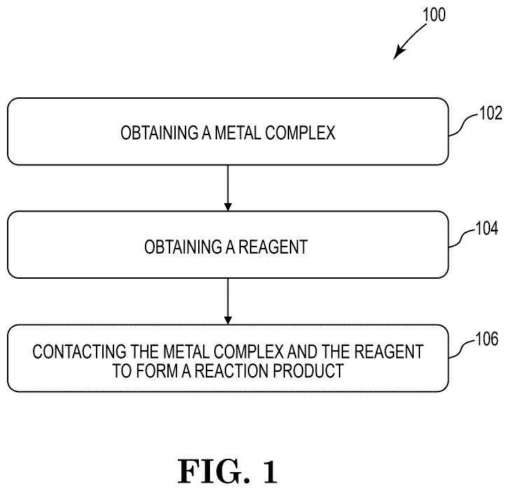

FIG. 1 is a flowchart of a method 100 for forming a reaction product, according to some embodiments. As shown in FIG. 1, the method 100 for forming a reaction product may comprise one or more of the following steps: obtaining 102 a metal complex, obtaining 104 a reagent, and contacting 106 the metal complex and the reagent to form a reaction product.

At step 102, in some embodiments, the method comprises obtaining a metal complex of the formula:

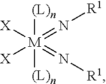

where:
M comprises at least one of a molybdenum, a tungsten, or any combination thereof;
each R¹ independently comprises a C₁-C₄ alkyl;
each L independently comprises at least one of an amino, a nitrile, an isonitrile, an ether, a diether, a thioether, a phosphino, a diphosphino, a heterocyclic, a guanidine, an amidine, an alkene, an alkyne, a cycloalkene, a cycloalkyne, or any combination thereof;
each n is independent 0 or 1; and
each X independently comprises a halogen.

In some embodiments, M comprises a molybdenum. In some embodiments, M comprises a tungsten.

In some embodiments, each R¹ independently comprises an alkyl. In some embodiments, each R¹ comprises the same alkyl. In some embodiments, each R¹ comprises a different alkyl.

In some embodiments, each L is the same. In some embodiments, each L is different. In some embodiments, each L is a Lewis base type ligand. In some embodiments, each L coordinates to M. In some embodiments, each L does not increase the oxidation state of M. In some embodiments, each L comprises an amino. In some embodiments, each L comprises a nitrile. In some embodiments, each L comprises an isonitrile. In some embodiments, each L comprises an ether. In some embodiments, each L comprises a diether. In some embodiments, each L comprises a thioether. In some embodiments, each L comprises a phosphino. In some embodiments, each L comprises a diphosphino. In some embodiments, each L comprises a heterocyclic. In some embodiments, each L comprises a guanidine. In some embodiments, each L comprises an amidine. In some embodiments, each L comprises an alkene. In some embodiments, each L comprises an alkyne. In some embodiments, each L comprises a cycloalkene. In some embodiments, each L comprises a cycloalkyne. In some embodiments, one L is an amino and the other L is not an amino. In some embodiments, one L is a nitrile and the other L is not a nitrile. In some embodiments, one L is an isonitrile and the other L is not an isonitrile. In some embodiments, one L is an ether and the other L is not an ether. In some embodiments, one L is a diether and the other L is not a diether. In some embodiments, one L is a thioether and the other L is not a thioether. In some embodiments, one L is a phosphino and the other L is not a phosphino. In some embodiments, one L is a diphosphino and the other L is not a diphosphino. In some embodiments, one L is a heterocyclic and the other L is not a heterocyclic. In some embodiments, one L is a guanidine and the other L is not a guanidine. In some embodiments, one L is an amidine and the other L is not an amidine. In some embodiments, one L is an alkene and the other L is not an alkene. In some embodiments, one L is an alkyne and the other L is not an alkyne. In some embodiments, one L is a cycloalkene and the other L is not a cycloalkene. In some embodiments, one L is a cycloalkyne and the other L is not a cycloalkyne.

In some embodiments, each n is independently a 0 or 1. In some embodiments, each n is the same. In some embodiments, each n is different. In some embodiments, each n is 0. In some embodiments, each n is 1. In some embodiments, one n is 0 and the other n is 1.

In some embodiments, each X independently comprises a halogen. In some embodiments, each X comprises the same halogen. In some embodiments, each X comprises a different halogen.

In some embodiments, the metal complex comprises the formula:

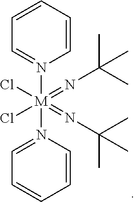

At step 104, in some embodiments, the method comprises obtaining a reagent of the formula:

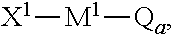

wherein:
X¹ comprises a halogen;
M¹ comprises at least one of an alkali metal, an alkaline earth metal, a zinc, or any combination thereof;
Q comprises (CH₂)_{b}—Si(R²)₃,
where:
each R² independently comprises a C₁-C₄ alkyl;
b is 0 to 4; and
a is 1 or 2.

In some embodiments, M¹ comprises an alkali metal. In some embodiments the alkali metal comprises at least one of a lithium, a sodium, a potassium, a rubidium, a caesium, a francium, or any combination thereof. In some embodiments, the alkali metal comprises a lithium. In some embodiments, the alkali metal comprises a sodium. In some embodiments, the alkali metal comprises a potassium. In some embodiments, the alkali metal comprises a rubidium. In some embodiments, the alkali metal comprises a caesium. In some embodiments, the alkali metal comprises a francium.

In some embodiments, M¹ comprises an alkaline earth metal. In some embodiments, the alkaline earth metal comprises at least one of a beryllium, a magnesium, a calcium, a strontium, a barium, a radium, or any combination thereof. In some embodiments, the alkaline earth metal comprises a beryllium. In some embodiments, the alkaline earth metal comprises a magnesium. In some embodiments, the alkaline earth metal comprises a calcium. In some embodiments, the alkaline earth metal comprises a strontium. In some embodiments, the alkaline earth metal comprises a barium. In some embodiments, the alkaline earth metal comprises a radium.

In some embodiments, M¹ comprises a zinc.

It will be appreciated that, although examples of M¹ are provided, M¹ can include any metal, including any of the alkali metals, alkaline earth metals, or any combination thereof, without departing from the scope of this disclosure.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, b is 0 to 4. In some embodiments, b is 0. In some embodiments, b is 1. In some embodiments, b is 2. In some embodiments, b is 3. In some embodiments, b is 4.

In some embodiments, a is 1 or 2. In some embodiments, when M¹ comprises an alkali metal, a is 1. In some embodiments, when M¹ comprises an alkaline earth metal, a is 1. In some embodiments, when M¹ comprises an alkali metal, a is 2. In some embodiments, when M¹ comprises an alkaline earth metal, a is 1. In some embodiments, when M¹ comprises a zinc, a is 2.

In some embodiments, the reagent comprises the formula Cl—Mg—(CH₂)Si(CH₃)₃.

At step 104, in some embodiments, the method comprises contacting the metal complex and the reagent to form a reaction product. In some embodiments, the contacting comprises contacting at room temperature. In some embodiments, the contacting comprises contacting at 0° C. In some embodiments, the contacting at 0° C. produces better results than contacting at room temperature. In some embodiments, the contacting comprises bringing the metal complex and the reagent into close or immediate proximity. In some embodiments, the contacting comprises bringing the metal complex and the reagent into direct physical contact. In some embodiments, the contacting comprises adding the metal complex to the reagent, or vice versa. In some embodiments, the contacting comprises mixing the metal complex and the reagent. In some embodiments, the contacting comprises stirring the metal complex and the reagent. In some embodiments, the contacting comprises agitating metal complex and the reagent. In some embodiments, the contacting comprises flowing the reagent through a vessel containing the metal complex. In some embodiments, the contacting comprises flowing the reagent over the metal complex.

In some embodiments, the reaction product has a purity of at least 85% as determined by a TGA residue at 300° C. For example, in some embodiments, the reaction product has a purity of at least 86%, at least 87%, at least 88%, at least 89%, at least 90%, at least 91%, at least 92%, at least 93%, at least 94%, at least 95%, at least 96%, at least 97%, at least 98%, at least 99%, or at least 100% as determined by a TGA residue at 300° C.

In some embodiments, the reaction product has a purity of 85% to 99.999% as determined by a TGA residue at 300° C., or any range or subrange between 85% to 99.999%. For example, in some embodiments, the reaction product has a purity of 86% to 99.99%, 87% to 99.9%, 88% to 99%, 89% to 98%, 90% to 97%, 91% to 96%, 92% to 95%, or 93% to 94. In some embodiments, the reaction product has a purity of 86% to 99.999%, 87% to 99.999%, 88% to 99.999%, 89% to 99.999%, 90% to 99.999%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.9% to 99.999%, or 99.99% to 99.999%. In some embodiments, the reaction product has a purity of 85% to 99.99%, 85% to 99.9%, 85% to 99%, 85% to 98%, 85% to 97%, 85% to 96%, 85% to 95%, 85% to 94%, 85% to 93%, 85% to 92%, 85% to 91%, 85% to 90%, 85% to 89%, 85% to 88%, 85% to 87%, or 85% to 86%.

In some embodiments, the reaction product comprises 1 parts per billion (ppb) to 10 ppb of M¹ based on a total weight of the reaction product, or any range or subrange between 1 ppb and 10 ppb. For example, in some embodiments, the reaction product comprises 2 ppb to 9 ppb, 3 ppb to 8 ppb, 4 ppb to 7 ppb, 5 ppb to 6 ppb of M¹ based on a total weight of the reaction product. In some embodiments, the reaction product comprises 1 ppb to 9 ppb, 1 ppb to 8 ppb, 1 ppb to 7 ppb, 1 ppb to 6 ppb, 1 ppb to 5 ppb, 1 ppb to 4 ppb, 1 ppb to 3 ppb, or 1 ppb to 2 ppb of M¹ based on a total weight of the reaction product. In some embodiments, the reaction product comprises 2 ppb to 10 ppb, 3 ppb to 10 ppb, 4 ppb to 10 ppb, 5 ppb to 10 ppb, 6 ppb to 10 ppb, 7 ppb to 10 ppb, 8 ppb to 10 ppb, or 9 ppb to 10 ppb of M¹ based on a total weight of the reaction product.

In some embodiments, M¹ comprises an alkali metal. In some embodiments the alkali metal comprises at least one of a lithium, a sodium, a potassium, a rubidium, a caesium, a francium, or any combination thereof. In some embodiments, the alkali metal comprises a lithium. In some embodiments, the alkali metal comprises a sodium. In some embodiments, the alkali metal comprises a potassium. In some embodiments, the alkali metal comprises a rubidium. In some embodiments, the alkali metal comprises a caesium. In some embodiments, the alkali metal comprises a francium.

In some embodiments, M¹ comprises an alkaline earth metal. In some embodiments, the alkaline earth metal comprises at least one of a beryllium, a magnesium, a calcium, a strontium, a barium, a radium, or any combination thereof. In some embodiments, the alkaline earth metal comprises a beryllium. In some embodiments, the alkaline earth metal comprises a magnesium. In some embodiments, the alkaline earth metal comprises a calcium. In some embodiments, the alkaline earth metal comprises a strontium. In some embodiments, the alkaline earth metal comprises a barium. In some embodiments, the alkaline earth metal comprises a radium.

In some embodiments, M¹ comprises a zinc.

In some embodiments, the reaction product comprises the formula:

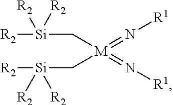

where:
M comprises at least one of a molybdenum, a tungsten, or any combination thereof;
each R¹ independently comprises an alkyl; and
each R² independently comprises an alkyl.

In some embodiments, M comprises a molybdenum. In some embodiments, M comprises a tungsten.

In some embodiments, each R¹ independently comprises an alkyl. In some embodiments, each R¹ comprises the same alkyl. In some embodiments, each R¹ comprises a different alkyl.

In some embodiments, each R² independently comprises an alkyl. In some embodiments, each R² comprises the same alkyl. In some embodiments, at least two R²s comprise the same alkyl. In some embodiments, at least two R²s comprise different alkyls. In some embodiments, each R² on a single silicon atom comprises the same alkyl. In some embodiments, each R² on a single silicon atom comprises a different alkyl. In some embodiments, at least two R²s on a single silicon atom comprise the same alkyl. In some embodiments, at least two R²s on a single silicon atom comprise different alkyls. In some embodiments, each R² on a first silicon atom comprises the same alkyl as each R² on a second silicon atom. In some embodiments, each R² on a first silicon atom comprises a different alkyl from each R² on a second silicon atom. In some embodiments, at least one R² on a first silicon atom comprises the same alkyl as at least one R² on a second silicon atom. In some embodiments, at least one R² on a first silicon atom comprises a different alkyl from at least one R² on a second silicon atom. In some embodiments, at least two R²s on a first silicon atom comprise the same alkyl as at least two R²s on a second silicon atom. In some embodiments, at least two R²s on a first silicon atom comprise a different alkyl from at least two R²s on a second silicon atom.

In some embodiments, each R¹ comprises the same alkyl as each R². In some embodiments, at least one R¹ comprises the same alkyl as at least one R². In some embodiments, at least one R¹ comprises a different alkyl than at least one R².

Any one or more of the embodiments disclosed herein shall be understood to be combinable without departing from the scope or spirit of the disclosure.

### Example 1: Synthesis of Bis(tert-butylimido)bis(trimethylsilylmethyl) Molybdenum (VI) and (^{t}BuN=)₂ (μ-^{t}BuN=)₂(Me₃SiCH₂)₂Mo₂ Side Product from (^{t}BuN=)₂MoCl₂ and Trimethylsilylmethyllithium

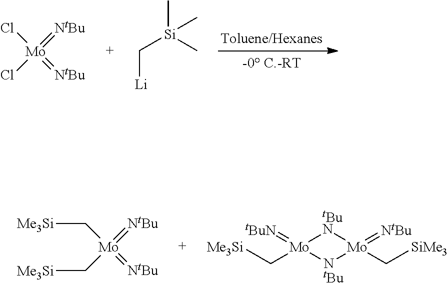

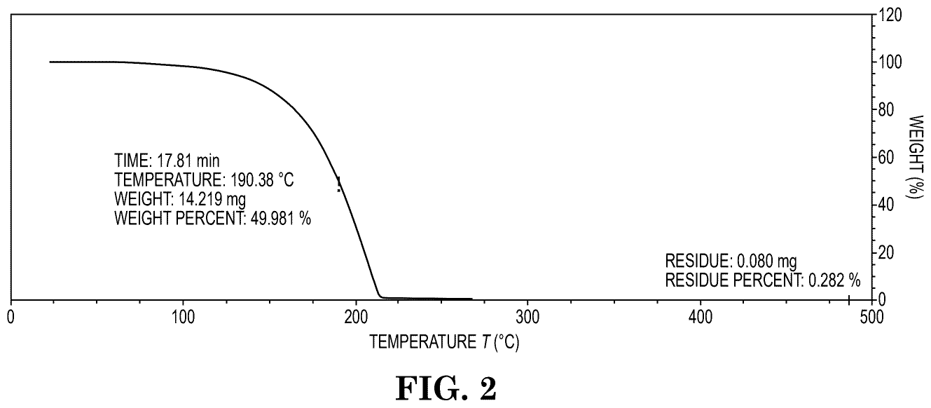

A 100 mL flask was equipped with a PTFE coated stir egg then charged with bis(tert-butylimino)molybdenum (VI) chloride (5.000 g, 1.000 Eq, 16.18 mmol) and 50 mL anhydrous toluene. The suspension was cooled in an ice bath, and 31.22 g of a 10.0 wt % trimethylsilylmethyllithium solution was added in a dropwise fashion. The reaction mixture was allowed to stir for 4 h at ambient temperature and was then stripped of solvent in-vacuo. The crude product, about 1.68 g (16.2 mmol, 25% yield), was transferred to a 10 mL distillation flask and an orange oil was distilled under vacuum at 110-112° C. The distilled oil was characterized by NMR and found to produce the following chemical shifts (5): ¹H NMR (400 MHz, d6-benzene, 298 K): δ 0.211 (s, 9H), 1.074 (s, 2H), 1.39 (s, 9H) ppm; ¹³C {¹H} NMR (100 MHz, d6-benzene, 289 K): δ 2.67, 33.12, 46.06, 67.88 ppm; and ²⁹Si {¹H} NMR (80 MHz, de-benzene, 289 K): δ 0.60 ppm. The distilled oil was analyzed using thermogravimetric analysis (TGA) The TGA of the distilled oil, depicted in FIG. 2, showed less than 1% overall residue with 50% mass loss at 153° C. Upon further heating of the distillation apparatus to an oil bath temp of about 210° C., a light green solid sublimed into the distillation head and over to the receiving flask (0.316 g, 6.0% yield). The green solid (^{t}BuN=)₂(μ-^{t}BuN=)₂(Me₃SiCH₂)₂Mo₂ was recrystallized from hot hexanes and characterized by NMR and single crystal XRD. The results of the green solid NMR is as follows: ¹H NMR (400 MHz, d6-benzene, 298 K): δ 0.543 (s, 9H), 1.104 (s, 9H), 1.14 (s, 2H), 1.60 (s, 9H) ppm; ¹³C {¹H} NMR (100 MHz, d6-benzene, 289 K): δ 3.57, 32.96, 34.83, 39.94 66.40, 67.16 ppm; and ²⁹Si {¹H} NMR (80 MHz, de-benzene, 289 K): δ 1.17 ppm.

### Example 2: Synthesis of Bis(tert-butylimido)bis(trimethylsilylmethyl) Molybdenum (VI) and (^{t}BuN=)₂(μ-^{t}BuN=)₂(Me₃SiCH₂)₂Mo₂ Side Product from (^{t}BuN=)₂MoCl₂(Py)₂ and Trimethylsilylmethyllithium

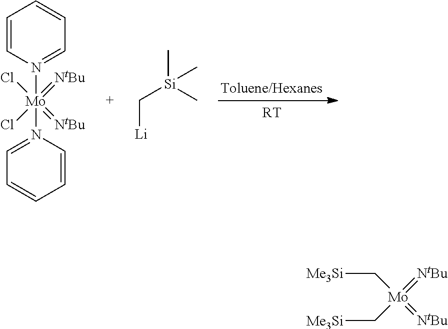

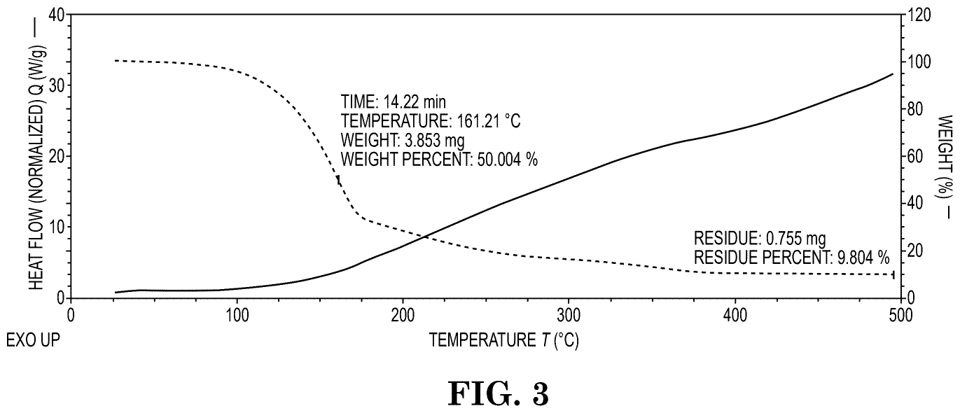

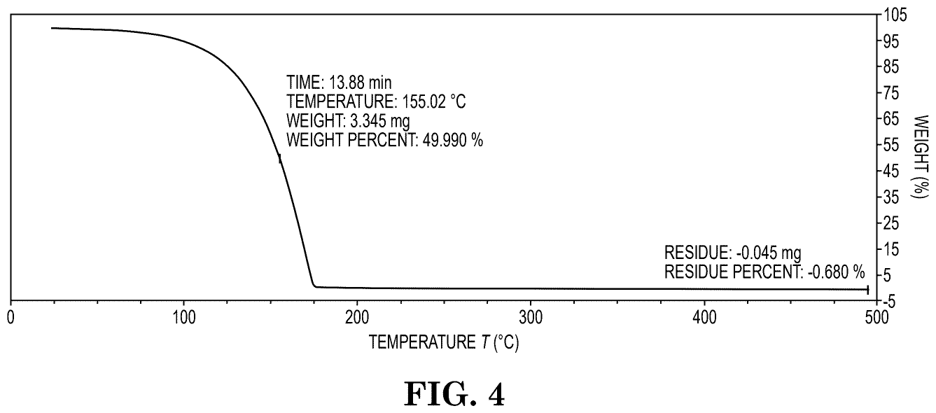

A 250 mL flask equipped with a PTFE coated stir egg was charged with bis(tert-butylimino)molybdenum (VI) chloride (5.000 g, 1.000 Eq, 16.18 mmol) and 125 mL of anhydrous toluene. To the suspension was added pyridine (2.559 g, 2.00 Eq, 32.35 mmol) to form the pyridine adduct. The solution was then treated with 31.22 g of a 10.0 wt % trimethylsilylmethyllithium solution in a dropwise fashion. The reaction mixture was allowed to stir for 18 h at ambient temperature and was then stripped of solvent in-vacuo. The residue was dissolved in 75 mL hexanes, filtered through a celite bed, and washed with an additional 25 mL of hexanes. The crude product was distilled in a short path distillation apparatus at 100 mtorr at a head temperature of 113 to 115° C. The mass of distillate collected was 2.09 g (31%). The (^{t}BuN=)₂(μ-BuN=)₂(Me₃SiCH₂)₂Mo₂ side product was also observed in the distillation pot residue. The TGA of the crude reaction is shown in FIG. 3 and the TGA of the distilled reaction product is shown in FIG. 4.

### Example 3: Synthesis of Bis(tert-butylimido)bis(trimethylsilylmethyl) Molybdenum (VI) from (^{t}BuN=)₂MoCl₂(THF)₂ and Trimethylsilylmethyl magnesium chloride

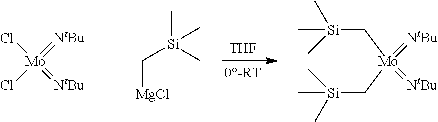

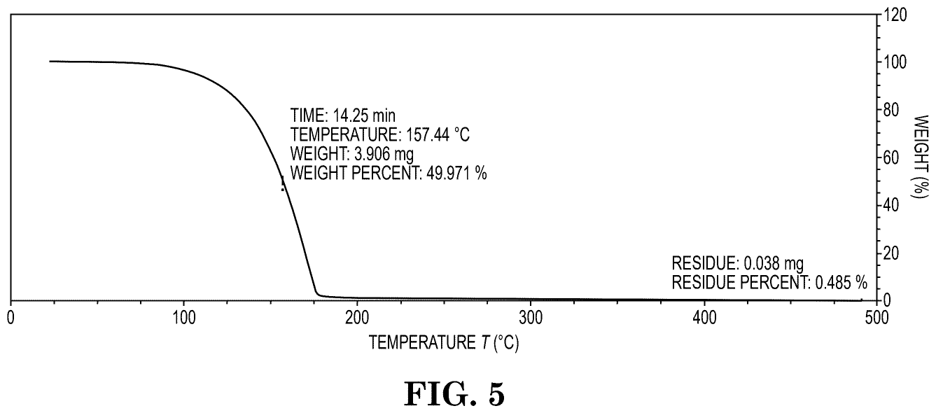

A 50 ml round bottom flask was equipped with a PTFE coated stir egg then charged with bis(tert-butylimino)molybdenum (VI) chloride (1.000 g, 1.000 Eq, 3.235 mmol) and 20 mL of anhydrous tetrahydrofuran. To the cooled (0° C.) green solution was introduced a solution of ((trimethylsilyl)methyl)magnesium chloride (951.0 mg, 4.314 mL, 1.50 molar, 2.00 Eq, 6.470 mmol) in a dropwise fashion. The reaction mixture was allowed to warm up slowly, was stirred for 18 h at ambient temperature, and was then stripped of solvent in-vacuo to give a yellow pasty solid. The product was extracted with anhydrous hexanes and the filtered extracts were concentrated in-vacuo to a red oil. The crude product was transferred into a 10 mL distillation flask and distilled using a short path distillation apparatus at 100 mtorr with a head temp ranging from 76 to 82° C. 0.701 g of an orange oil was collected (53% yield). The TGA of the distilled reaction product is shown in FIG. 5.

### Aspects

Various Aspects are described below. It is to be understood that any one or more of the features recited in the following Aspect(s) can be combined with any one or more other Aspect(s).
Aspect 1. A composition comprising:
   a metal complex of the formula:

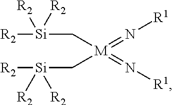

where:
   M comprises at least one of a molybdenum, a tungsten, or any combination thereof;
   each R¹ independently comprises a C₁-C₄ alkyl;
   each R² independently comprises a C₁-C₄ alkyl; and
wherein the metal complex has a purity of at least 85% as determined by a thermogravimetric analysis (TGA) residue at 300° C.
Aspect 2. The composition according to Aspect 1, wherein M comprises the molybdenum.
Aspect 3. The composition according to any of Aspects 1-2, wherein M comprises the tungsten.
Aspect 4. The composition according to any of Aspects 1-3, wherein the metal complex comprises the formula:

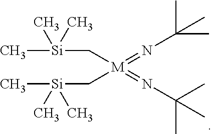

Aspect 5. The composition according to any of Aspects 1-3, wherein the metal complex has a purity of 85% to 99.999% as determined by a TGA residue at 300° C.
Aspect 6. A composition comprising:
   a molybdenum complex of the formula:

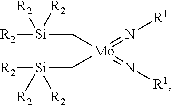

where:
   each R¹ independently comprises a C₁-C₄ alkyl; and
   each R² independently comprises a C₁-C₄ alkyl; and
0.001% to 15% by weight of an impurity based on a total weight of the composition.
Aspect 7. The composition according to Aspect 6, wherein the molybdenum complex comprises the formula:

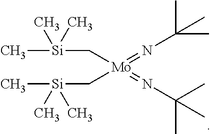

Aspect 8. The composition according to any of Aspects 6-7, wherein the composition comprises 85% to 99.999% by weight of the molybdenum complex based on the total weight of the composition.
Aspect 9. The composition according to any of Aspects 6-8,
   wherein the impurity comprises the formula:

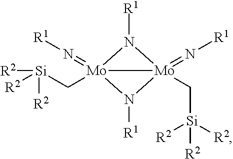

where:
   each R¹ independently comprises a C₁-C₄ alkyl; and
   each R² independently comprises a C₁-C₄ alkyl.
Aspect 10. The composition according to any of Aspects 6-9, wherein the impurity comprises the formula:

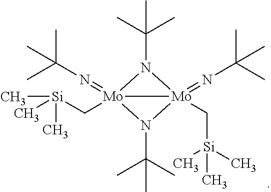

Aspect 11. A composition comprising:
   a compound of the formula:

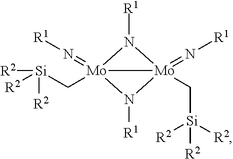

where:
   each R¹ independently comprises a C₁-C₄ alkyl;
   each R² independently comprises a C₁-C₄ alkyl.
Aspect 12. The composition according to Aspect 11, wherein the compound comprises the formula:

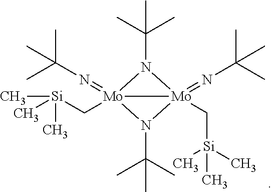

Aspect 13. The composition according to any of Aspects 11-12, wherein the compound is present in an amount of 0.001% to 15% by weight based on a total weight of the composition.
Aspect 14. A method comprising:
   obtaining a metal complex of the formula:

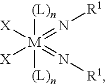

where:
   M comprises at least one of a molybdenum, a tungsten, or any combination thereof;
   each R¹ independently comprises a C₁-C₄ alkyl;
   each L independently comprises at least one of an amino, a nitrile, an isonitrile, an ether, a diether, a thioether, a phosphino, a diphosphino, a heterocyclic, a guanidine, an amidine, an alkene, an alkyne, a cycloalkene, a cycloalkyne, or any combination thereof;
   each n is independent 0 or 1; and
   each X independently comprises a halogen;
obtaining a reagent of the formula:

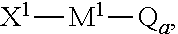

wherein:
   X¹ comprises a halogen;
   M¹ comprises at least one of an alkali metal, an alkaline earth metal, a zinc, or any combination thereof; and
   Q comprises (CH₂)_{b}—Si(R²)₃,
   where:
   each R² independently comprises a C₁-C₄ alkyl;
   b is 0 to 4; and
   a is 1 or 2; and
contacting the metal complex and the reagent to form a reaction product,
   wherein the reaction product has a purity of at least 85% as determined by a TGA residue at 300° C.
Aspect 15. The method according to Aspect 14, wherein the reaction product comprises the formula:

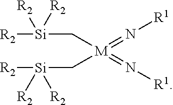

Aspect 16. The method according to any of Aspects 14-15, wherein the reaction product has a purity of 85% to 99.999% as determined by a TGA residue at 300° C.
Aspect 17. The method according to any of Aspects 14-16, wherein the reaction product comprises 1 to 10 parts per billion (ppb) of M¹ based on a total weight of the reaction product.
Aspect 18. The method according to any of Aspects 14-17, wherein the metal complex comprises the formula:

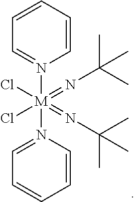

Aspect 19. The method according to any of Aspects 14-18, wherein the reagent comprises the formula Cl—Mg—(CH₂)Si(CH₃)₃.
Aspect 20. The method according to any of Aspects 14-19, wherein the contacting comprises contacting at room temperature.

What is claimed is:

1. A composition comprising:
a metal complex of the formula: 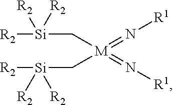
where:
M comprises at least one of a molybdenum, a tungsten, or any combination thereof;
each R¹ independently comprises a C₁-C₄ alkyl; and
each R² independently comprises a C₁-C₄ alkyl;
wherein the metal complex is present in the composition at a purity of at least 85% as determined by a thermogravimetric analysis (TGA) residue at 300° C.

2. The composition of claim 1, wherein M comprises the molybdenum.

3. The composition of claim 1, wherein M comprises the tungsten.

4. The composition of claim 1, wherein the metal complex comprises the formula:

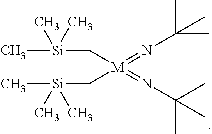

5. The composition of claim 1, wherein the metal complex is present in the composition at a purity of 85% to 99.999% as determined by a TGA residue at 300° C.

6. A composition comprising:
a molybdenum complex of the formula: 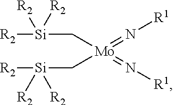
where:
each R¹ independently comprises a C₁-C₄ alkyl; and
each R² independently comprises a C₁-C₄ alkyl; and
0.001% to 15% by weight of an impurity based on a total weight of the composition.

7. The composition of claim 6, wherein the molybdenum complex comprises the formula:

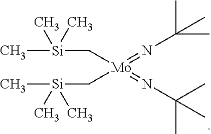

8. The composition of claim 6, wherein the composition comprises 85% to 99.999% by weight of the molybdenum complex based on the total weight of the composition.

9. The composition of claim 6,
wherein the impurity comprises the formula: 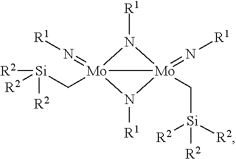
where:
each R¹ independently comprises a C₁-C₄ alkyl; and
each R² independently comprises a C₁-C₄ alkyl.

10. The composition of claim 9, wherein the impurity comprises the formula:

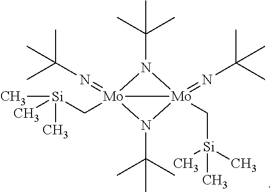

11. A composition comprising:
a compound of the formula: 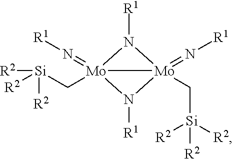
where:
each R¹ independently comprises a C₁-C₄ alkyl; and
each R² independently comprises a C₁-C₄ alkyl.

12. The composition of claim 11, wherein the compound comprises the formula:

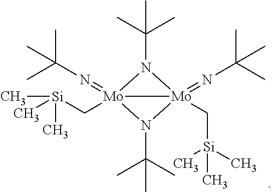

13. The composition of claim 11, wherein the compound is present in an amount of 0.001% to 15% by weight based on a total weight of the composition.

14. A method comprising:
obtaining a metal complex of the formula: 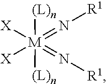
where:
M comprises at least one of a molybdenum, a tungsten, or any combination thereof;
each R¹ independently comprises a C₁-C₄ alkyl;
each L independently comprises at least one of an amino, a nitrile, an isonitrile, an ether, a diether, a thioether, a phosphino, a diphosphino, a heterocyclic, a guanidine, an amidine, an alkene, an alkyne, a cycloalkene, a cycloalkyne, or any combination thereof;
each n is independent 0 or 1; and
each X independently comprises a halogen;
obtaining a reagent of the formula: 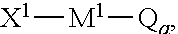
wherein:
X¹ comprises a halogen;
M¹ comprises at least one of an alkali metal, an alkaline earth metal, a zinc, or any combination thereof; and
Q comprises (CH₂)_{b}—Si(R²)₃,
where:
each R² independently comprises a C₁-C₄ alkyl;
b is 0 to 4; and
a is 1 or 2; and
contacting the metal complex and the reagent to form a reaction product,
wherein the reaction product has a purity of at least 85% as determined by a TGA residue at 300° C.

15. The method of claim 14, wherein the reaction product comprises the formula:

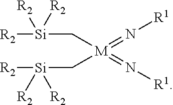

16. The method of claim 14, wherein the reaction product has a purity of 85% to 99.999% as determined by a TGA residue at 300° C.

17. The method of claim 14, wherein the reaction product comprises 1 to 10 parts per billion (ppb) of M¹ based on a total weight of the reaction product.

18. The method of claim 14, wherein the metal complex comprises the formula:

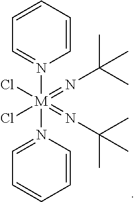

19. The method of claim 14, wherein the reagent comprises the formula Cl—Mg—(CH₂)Si(CH₃)₃.

20. The method of claim 14, wherein the contacting comprises contacting at room temperature.
